(19) United States
(12) Patent Application Publication
(10) Pub. No.: US 2026/0259811 A1
(43) Pub. Date: Sep. 3, 2026

(54) METHODS FOR ENFORCING FAIRNESS OF SHARED SYSTEM RESOURCE UTILIZATION

(71) Applicant: NVIDIA Corp., Santa Clara, CA (US)

(72) Inventors: John Kelley, Fort Collins, CO (US); Bruce Kester Holmer, Belmont, CA (US)

(73) Assignee: NVIDIA Corp., Santa Clara, CA (US)

(21) Appl. No.: 19/068,451

(22) Filed: Mar. 3, 2025

(51) Int. Cl. G06F 11/34

(52) U.S. Cl. CPC G06F 11/3419; G06F 11/3485

(57) ABSTRACT

Mechanisms are described for throttling the resource demands of multiple system components. For each of the components generating demands to use a shared system resource, at least one time interval is configured, and during the time interval indications of whether the resource is over-utilized or under-utilized and sampled. After a conclusion of the time interval, the time interval of every component is expanded or is contracted, as determined by the indications.

### BACKGROUND

A system may include multiple source components that generate requests to one or more shared system resource. The shared system resource may in turn generate feedback to the source components indicating whether it is being over-utilized or under-utilized. The source components may utilize this feedback to implement a control loop, throttling down their request bandwidth to the shared system resource when the feedback indicates it is too busy, and throttling up their request bandwidth to the shared system resource when the feedback indicates it has additional availability.

It may be challenging to achieve balanced control loop action by each of the independent source nodes such that their demand on shared system resources is fairly throttled.

For example, data processing cores in a computer system may receive feedback from memory channels. Each core may throttle down its request generation bandwidth independently from the other cores, with no central controller assigned to orchestrate the throttling behavior of the cores and no coordination between the cores. In these scenarios, conventional throttling mechanisms may lead in some cases to excessive throttling imbalances among the cores.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary system that may utilize the disclosed throttling mechanisms.

FIG. 2 depicts throttling logic in one embodiment.

FIG. 3 depicts utilization of a filter in throttling adjustments.

FIG. 4 depicts throttling logic in another embodiment.

FIG. 5 depicts an integrated circuit in accordance with one embodiment.

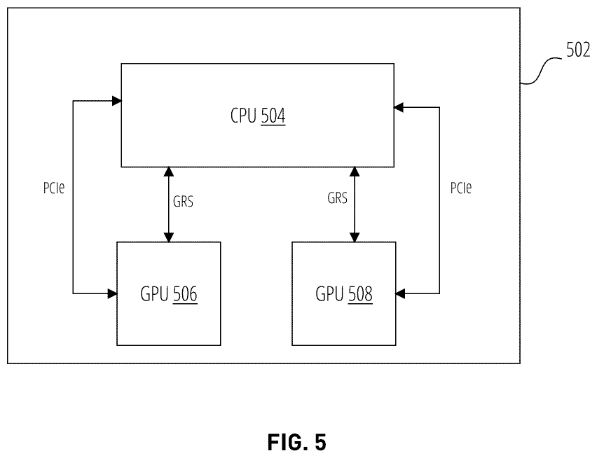

FIG. 6 depicts a computing system in accordance with one embodiment.

FIG. 7 depicts an exemplary data processing system that may utilize the disclosed mechanisms.

FIG. 8 illustrates an exemplary data center 800, in accordance with at least one embodiment.

### DETAILED DESCRIPTION

Disclosed herein are mechanisms to enable components operating as independent actors to throttle their resource demand bandwidth independently from one another in a manner that converges toward equitable distribution of resource demand bandwidth among the components. The components may self-throttle their resource bandwidth demands without coordinating with other components that are contending for the shared resource, and without coordination from a central controller. The components may have homogeneous traffic service settings, or heterogeneous traffic settings (e.g., different Quality of Service requirements).

In one embodiment, time periods are configured for different components to control a rate at which resource bandwidth adjustments up or down for each component are applied. Separate time periods may be configured for up-throttling and for down-throttling. Control logic is operated to expand or contract the configured time periods based on a directionality of the throttling to perform (up or down) and the current throttle levels.

For example, if a component is being throttled down (e.g., to coerce it to generate fewer requests to a memory), an amount of time may be subtracted from the time period between making down-throttling adjustments for the component to make it throttle down faster, or may be added to the time interval to make it throttle down slower. Likewise, if a component is being throttled up (e.g., to enable it to generate more requests to a memory), an amount of time may be subtracted from (for faster up-throttling) or added to (for slower up-throttling) the time period between making up-throttling adjustments for the component. In some embodiments the adjustments to the time period may be scaled individually per component. For example, scaling the adjustment to the time period by a value proportional to the component's outstanding transaction limit (OT limit) coerces higher-demand components to throttle down at a faster rate than lower-demand components.

Scaling upward adjustments to the up-throttling time period, e.g., by a value proportional to the component's OT limit, enables higher-demand components to throttle up at a slower rate than lower-demand components.

In one operating scenario a plurality of components contend simultaneously for bandwidth to a resource. In another scenario, a plurality of components contend simultaneously for bandwidth to a resource and a new component that was not previously contending for the resource begins contending for the resource. The disclosed mechanisms are applicable to either of these scenarios to enable equitable, uncoordinated throttling either up or down among the components. The disclosed mechanisms may exhibit superior throttling fairness for independently operating components than do conventional mechanisms that throttle to an extent based primarily or exclusively on the level of a component's current request bandwidth.

In one operating scenario a shared system resource may provide multiple (e.g., three) types of feedback signals in response to requests. A first signal (B1) may indicate that a system resource is under-utilized, a second signal (B2) may indicate that a system resource is neither over-nor under-utilized, and a third signal (B3) may indicate that a system resource is over-utilized. More generally, any practical variety of feedback signals may be present in a system, indicating various degrees of over- or under-utilization of a shared resource.

In conventional throttling mechanisms components may respond independently to B1 or B3 type feedback from a shared resource by throttling their OT limit on the resource up or down, respectively. Unlike conventional approaches, the disclosed throttling mechanisms may not adjust a component's OT limit, but instead may configure a time interval (e.g., in clock cycles) for each component during which the feedback signals are sampled. Separate time intervals may be configured for each component for throttling their bandwidth up or down, and the separate time intervals may be different.

At end of a time interval, sampling results for different feedback signal types (e.g., B1, B2, and/or B3) may be utilized to determine a compression or expansion factor or amount for each component's configured time intervals. In one embodiment, the feedback signal types may be counted; other embodiments may utilize more elaborate sampling mechanisms during the time intervals, such as a digital filter.

By way of example, a system may comprise two central processing unit (CPU) cores that contend for bandwidth on a memory channel. One of the cores may generate memory requests (reads, writes) at a much higher rate than the other core. Both cores may receive B3 feedback signals back from the memory channel in response to their requests, indicating the channel is over-utilized but not distinguishing which component is primarily responsible for the over-utilization. The components may not be aware of one another's memory utilization rates, and therefore each component may throttle down their request rate by some proportionally-similar amount in response to the B3 feedback. This may lead to unfair throttling scenarios if only one of the components bears primary responsibility for the overutilization of the memory channel. Utilizing the disclosed mechanisms, the heavy requester's sampling time interval may be compressed at a faster rate than the slower requester's sampling time interval, resulting in a more equitable distribution of the down-throttling between the two components.

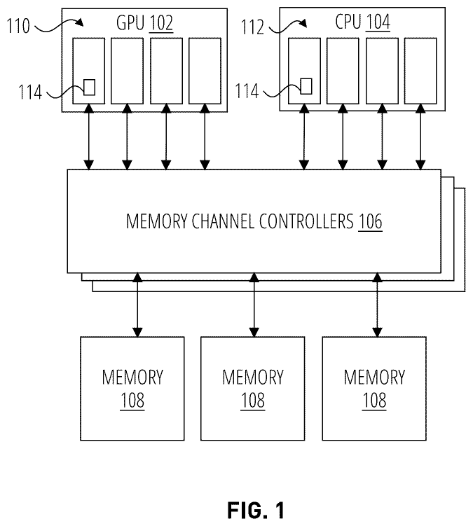

FIG. 1 depicts an exemplary system that may utilize the disclosed throttling mechanisms. The system comprises at least one graphics processing unit (GPU 102), at least one central processing unit (CPU 104), and a memory channel controllers 106 that arbitrate access to physical memory 108, e.g., to banks of dynamic random access memory (DRAM).

Each GPU 102 may comprise multiple streaming multiprocessors 110 (a type of parallel execution unit well known in the art), and each CPU 104 may comprise multiple processor cores 112 (also a well-known type of parallel execution unit).

The processor cores 112 contend for bandwidth to and from the memory channel controllers 106. Some or all of the processor cores 112 may comprise throttling logic 114 that operates in accordance with the mechanisms described herein. The streaming multiprocessors 110 may also contend for bandwidth to and from the memory channel controllers 106. Some or all of the streaming multiprocessors 110 may comprise throttling logic 114 that operates in accordance with the mechanisms described herein.

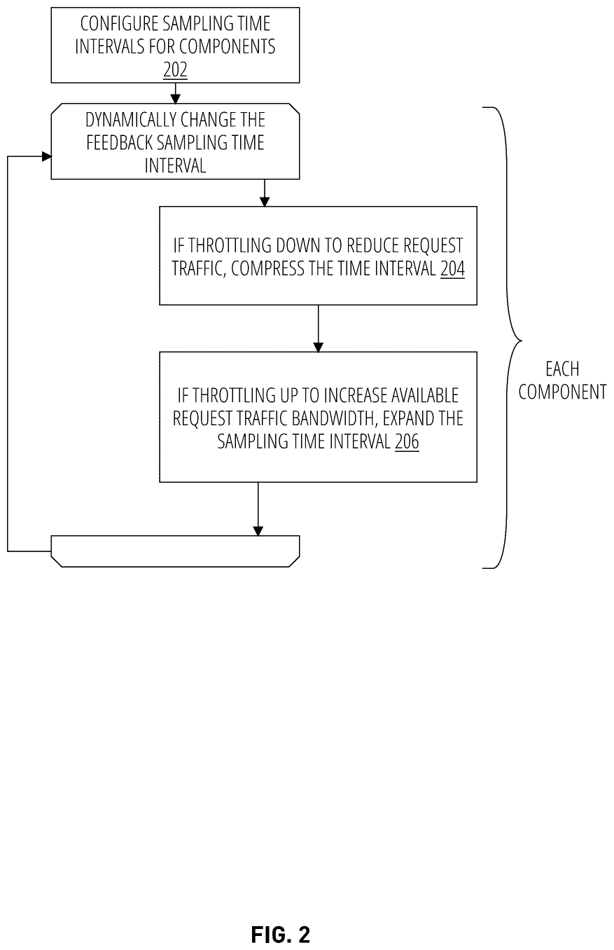

FIG. 2 depicts throttling logic in one embodiment. Sampling time intervals for multiple components are initially configured (block 202). These initial sampling intervals may be the same for the components, or varied among the components in various ways. Separate sampling intervals may be configured for up-throttling control and for down-throttling control.

In one embodiment, every member of a set of N>1 components is initially configured with a sampling time interval that is proportional in some manner to their configured OT limits. The components may be homogeneous in the sense that their service requirements (e.g., latency, reliability) from a shared system resource are approximately the same. The homogeneous components may for example be execution cores of a CPU or streaming multiprocessors of a GPU.

The components may be configured initially with differing OT limits based on their individual in-flight request bandwidths to the shared system resource. When a component's OT limit is reached or exceeded, the component stops launching new requests to use the shared system resource. Heavier requesters may have a higher OT limit configured than lighter requesters. The configured OT limits for the components may remain constant as the sampling time intervals are expanded or compressed over time to effectuate throttling.

In one embodiment, during operation, each component independently makes adjustments to it's sampling time interval(s) after each sampling interval, based on whether feedback from the shared system resource indicates over-utilization, under-utilization, or neutral utilization. If the shared system resource is over-utilized or under-utilized, each component independently compresses (block 204) or expands (block 206) its sampling time intervals, respectively.

In one embodiment, a time interval is compressed or expanded by a time increment:

$${T}_{i + 1} = {T}_{i} - {C}_{1} ( throttle down utilization of a shared system resource )$$

$${T}_{i + 1} = {T}_{i} + {C}_{2} ( throttle up utilization of a shared system resource )$$

where Tᵢ is the sampling interval that just concluded, Tᵢ₊₁ is the next sampling interval, and C is an amount of adjustment. In one embodiment, the values of C for a component may be configured to values that reflect the component's OT limit, e.g., heavier requesters may have a higher setting for C₁ and a lower setting for C₂ that do lighter requesters. In another embodiment, the values of C may be set the same for all components, but the components may be initially configured with sampling time intervals that inversely reflect their OT limit settings, e.g., heavier requesters are initially configured with smaller sampling intervals than lighter requesters. Either mechanism results in heavier requesters throttling down faster and throttling up slower than lighter ones.

The parameters C may also be varied appropriately among the components to reflect heterogeneous traffic service requirements, e.g., where some components are CPU processor cores 112 and some components are GPU streaming multiprocessors 110.

In some implementations, scale factors/weights on the sampling interval adjustment may be introduced. Depending on the particular system environment and the nature of the components used, the scale factor/weights may be determined empirically using readily available profiling tools, based on (1) a number of response samples of particular types received in the time period, (2) a number of such responses exceeding a set threshold (e.g., R-Rot), (3) on the OT limits of the components, (4) heterogeneous traffic service requirements among the components, or (5) a combination of these factors. For example:

$${T}_{i + 1} = {T}_{i} - α * C ( throttle down )$$

$${T}_{i + 1} = {T}_{i} + β * C ( throttle up )$$

where α and β are weights/scale factors based on the factors above. In some embodiments α=β and in other embodiments α< >β, depending on system performance metrics.

In yet another embodiment, the scaled throttling may be implemented as:

$${T}_{i + 1} = α * {T}_{i} ( throttle down )$$

$${T}_{i + 1} = β * {T}_{i} ( throttle up )$$

where β=1/a in some embodiments.

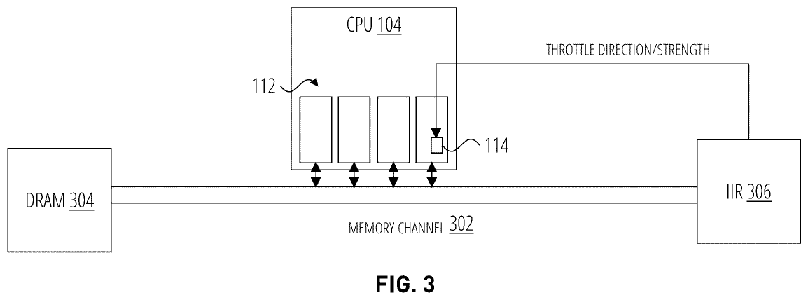

FIG. 3 depicts utilization of a filter in throttling adjustments. The example system depicted in FIG. 3 comprises a CPU 104 with multiple processor cores 112, each comprising throttling logic 114. The processor cores 112 contend for bandwidth on a memory channel 302 to a DRAM 304. A filter 306, e.g., an infinite impulse response (IIR) filter, generates throttle direction and throttle strength signals to the throttling logic 114 in each of the processor cores 112.

In some embodiments a low-pass digital filter, such as the depicted infinite IIR filter 306, may be utilized to perform the sampling of feedback signals and determine a direction (and hence potentially a time interval) to throttle. In some embodiments, a scale factor for the adjustments to the throttling interval (the interval for making throttle adjustments) may be implemented as a strength of the filter output (e.g., the filter may output higher values for effecting larger interval adjustments and vice-versa). In these embodiments digital filter output indicates a direction of the throttle and a scale factor for the throttle.

The filter samples feedback signals from the shared system resource over a configured first interval (e.g., based on the filter length) that may be different than a second interval used to implement the throttle. The first interval may therefore determine a window for sampling by the filter to determine a direction (and in some embodiments, a strength) of throttle, and the second interval may determine a rate at which the second interval is compressed or expanded. These mechanisms are depicted in the tables below.

No Scaling By Filter Strength

| | Component | Time Interval for | Time Interval |
|---|---|---|---|
| | Request | Effecting Throttle | Adjustment |
| Filter Output | Bandwidth | Changes | Mechanism |
| −1 (shared | Relatively | Reduce faster | Tᵢ₊₁ = Tᵢ − C |
| system resource | high | | |
| over-utilized) | Relatively | Reduce slower | |
| | low | | |
| 0 (hold) | Relatively | N/A | N/A |
| | high | | |
| | Relatively | | |
| | low | | |
| +1 (shared | Relatively | Increase Slower | Tᵢ₊₁ = Tᵢ + C |
| system resource | high | | |
| under-utilized) | Relatively | Increase Faster | |
| | low | | |

With Scaling By Filter Strength

| | Component | Time Interval for | Time Interval |
|---|---|---|---|
| | Request | Effecting Throttle | Adjustment |
| Filter Output | Bandwidth | Changes | Mechanism |
| −α (shared | Relatively | Reduce faster | Tᵢ₊₁ = Tᵢ − αC |
| system resource | high | | |
| over-utilized) | Relatively | Reduce slower | |
| | low | | |
| 0 (hold) | Relatively | N/A | N/A |
| | high | | |
| | Relatively | | |
| | low | | |
| +α (shared | Relatively | Increase Slower | Tᵢ₊₁ = Tᵢ + αC |
| system resource | high | | |
| under-utilized) | Relatively | Increase Faster | |
| | low | | |

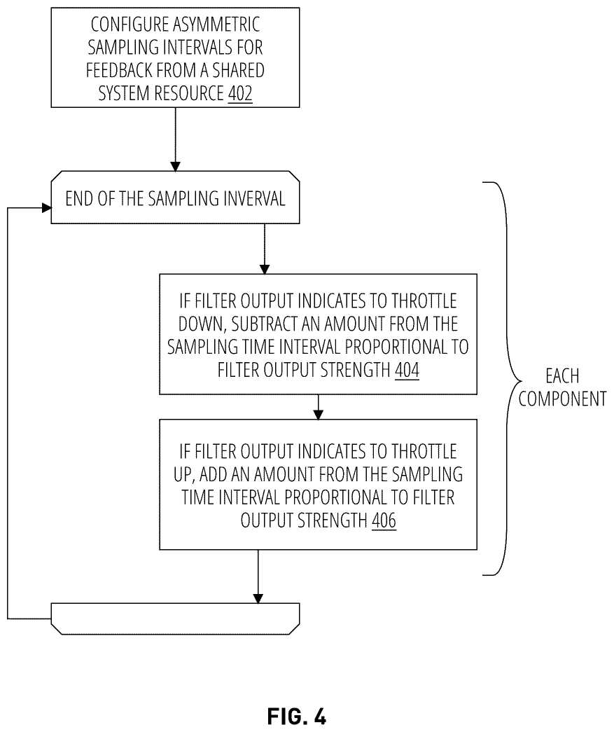

FIG. 4 depicts throttling logic in another embodiment. Feedback sampling intervals from the shared system resource are configured for each component (block 402). The sampling intervals are made asymmetric (different sizes) thereby enabling different rates of their expansion or contraction by way of the following actions. At the end of each sampling interval, the output of a filter is applied to determine both the strength and direction of adjustments to the sampling intervals (block 404 and block 406). Bandwidth-heavy components with sampling intervals initialized to smaller sizes will apply expansions or contractions to their sampling windows at a faster rate than lighter bandwidth components initialized with wider sampling intervals.

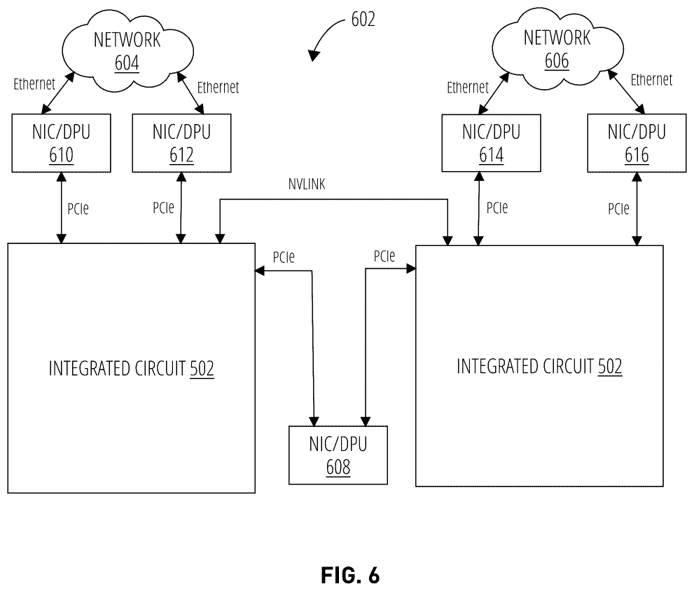

FIG. 6 is a block diagram of a computing system 602 having two processing devices coupled to each other and to multiple networks 604, 606 according to at least one embodiment. The computing system 602 is designed with multiple integrated circuits 502 (referred to as processing devices), where each integrated circuit includes a central processing unit 504 and two (or more) 506, 508, forming a powerful and flexible architecture. These processing devices may be interconnected via an NVLink (or other high-speed interconnect), enabling high-speed communication between the processing devices, and may also communicate through a Network Interface Card (NIC) or Data Processing Unit (DPU) 608 to enable efficient data transfer across the 602. In some embodiments, aspects of the mechanisms disclosed herein may be implemented in a DPU or NIC.

A NIC and a DPU may serve different roles in network architecture, despite both facilitating network connectivity. A NIC may primarily provide a hardware interface to connect elements of a computing system to a network. A NIC may handle basic network communication tasks such as formatting, sending, and receiving data packets. The processing capabilities of a NIC may be limited to traditional network processing tasks.

A DPU comprises a specialized processing unit designed to offload and accelerate complex data processing tasks from the NIC or computing system. A NIC may combine a network interface, programmable processing, and storage capabilities and may perform tasks such as security, storage virtualization, and network telemetry.

The coupling of the processing devices via NVLink enables data exchange and parallel processing, enhancing overall computational performance. A 602 configured in this manner may process complex, multi-network tasks with high bandwidth and low latency. This configuration makes the 602 suitable for demanding applications that consume significant processing power by current standards, such as artificial intelligence (AI), machine learning (ML), and data-intensive computing, while providing robust connectivity and scalability across various networked environments.

As depicted in the example embodiment of FIG. 6, the central processing unit 504 may be coupled to the 506, 508 via a die-to-die (D2D) or chip-to-chip (C2C) interconnect such as a Ground-Referenced Signaling interconnect (GRS interconnect). The central processing unit 504 may be coupled to the 506, 508 via PCIe (Peripheral Component Interconnect Express) interconnects.

The central processing unit 504 component of the integrated circuit 502 may be coupled to one or more network interface cards (NICs) or data processing units (DPUs), and these may be coupled to one or more networks. For example, as depicted in FIG. 6, the central processing unit 504 component of one of the integrated circuits 502 may be coupled to a network 604 via a pair of NICs or DPUs 610, 612. The NICs or DPUs 610, 612 may be coupled to the network 604 in a number of ways, for example over Ethernet (ETH), NVLINK, or InfiniBand (IB) connections. Likewise, the central processing unit 504 component of the other integrated circuit 502 may be coupled to a network 606 via a pair of NICs or DPUs 614, 616, and the NICs or DPUs 614, 616 may be coupled to the network 606 for example over Ethernet (ETH), NVLINK, or InfiniBand (IB) connections, for example.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

The mechanisms disclosed herein may be utilized on such systems to fairly throttle demand on shared system resources from multiple components of such systems, such as from multiple streaming multiprocessors of graphics processing units, multiple computing cores of central processing units, and/or from a mixture of cores and streaming multiprocessors.

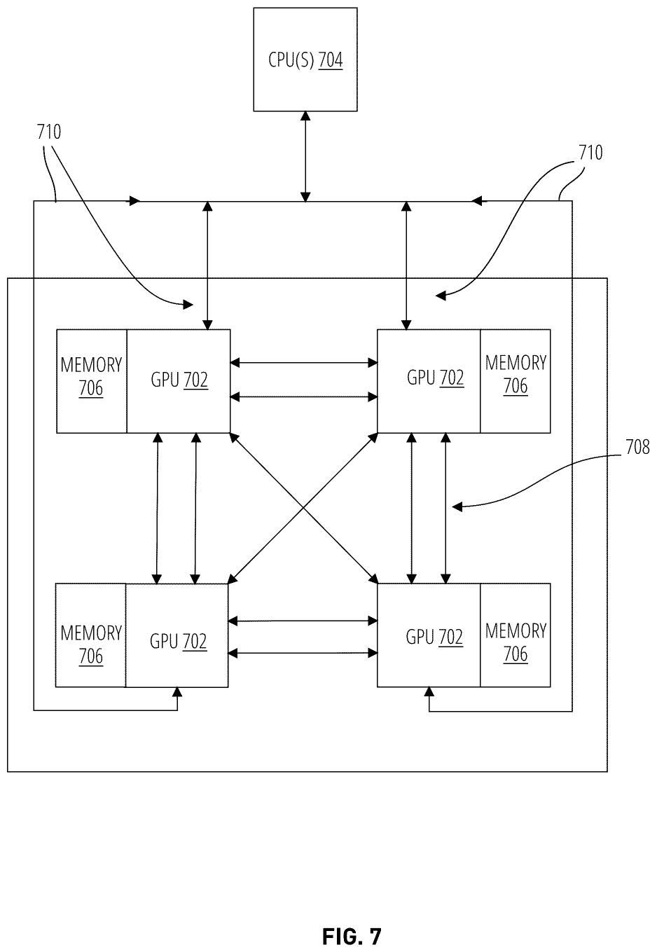

FIG. 7 is a conceptual diagram of a processing system implemented using multiple parallel processing units, e.g., graphics processing units 702, in accordance with an embodiment. The processing system includes one or more central processing unit 704 and multiple graphics processing units 702 with respective memories 706. The NVLink 708 is a communication fabric technology utilized in, for example, systems utilizing graphics processing units 702 from Nvidia Corp.®. The NVLink 708 provides high-speed communication links between each of the graphics processing units 702.

Although a particular number of NVLink 708 and interconnect 710 connections are depicted, the number of connections to each graphics processing unit 702 and the central processing unit 704 may vary. In some embodiments, a switch (not depicted) may interface between the interconnect 710 and the central processing units 704.

The graphics processing units 702, memories 706, and NVLink 708 connections may be situated on a single semiconductor platform to form a parallel processing module. Similarly, the graphics processing units 702, memories 706, and interconnect 710 may be situated on a single semiconductor platform to form the parallel processing module.

In another embodiment, the NVLink 708 provides one or more high-speed communication links between each of the graphics processing units 702 and the central processing units 704, and a switch is utilized to interface between the interconnect 710 and each of the graphics processing units 702.

In yet another embodiment (not shown), the interconnect 710 provides one or more communication links between each of the graphics processing units 702 and the central processing units 704 and a switch interfaces between each of the graphics processing units 702 using the NVLink 708 to provide one or more high-speed communication links between the parallel processing unit modules. In another embodiment (not shown), the NVLink 708 provides one or more high-speed communication links between the graphics processing units 702 and the central processing units 704 through a switch. In yet another embodiment (not shown), the interconnect 710 provides one or more communication links between each of the parallel processing unit modules directly. One or more of the NVLink 708 high-speed communication links may be implemented as a physical NVLink interconnect or either an on-chip or on-die interconnect.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module may be implemented as a circuit board substrate and each of the parallel graphics processing units 702, central processing units 704, and/or memories 706 may be packaged devices.

In an embodiment, the NVLink 708 enables direct load/store/atomic access from the central processing units 704 to the memories 706 of each graphics processing units 702. In an embodiment, the NVLink 708 supports coherency operations, allowing data read from the memories 706 to be stored in the memory hierarchy of the central processing units 704, reducing cache access latency for the central processing units 704. In an embodiment, the NVLink 708 includes support for Address Translation Services (ATS), enabling the graphics processing units 702 to directly access page tables of the central processing units 704.

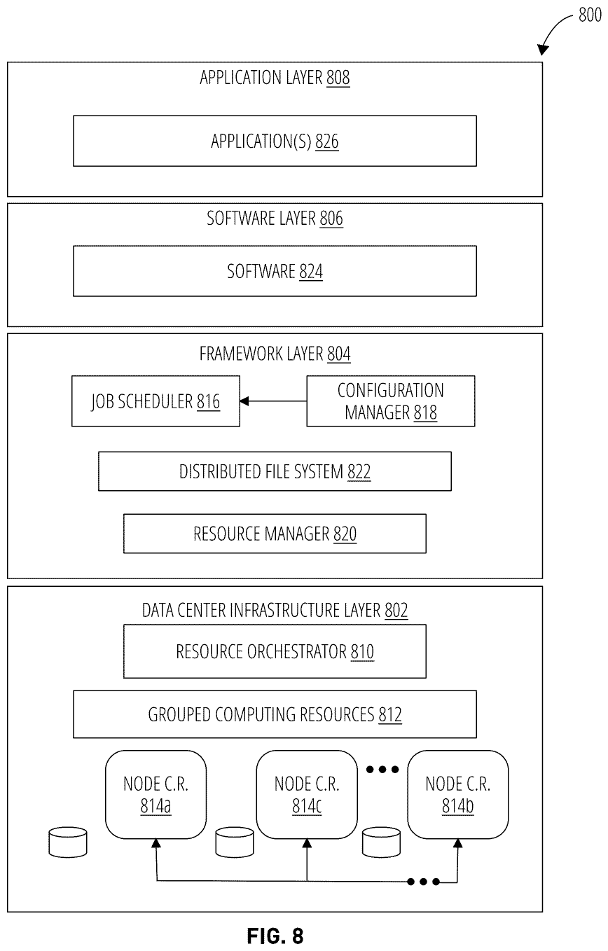

FIG. 8 depicts an exemplary data center 800, in accordance with at least one embodiment. In at least one embodiment, data center 800 includes, without limitation, a data center infrastructure layer 802, a framework layer 804, a software layer 806, and an application layer 808.

The data center 800 may comprise multiple data processors, e.g., graphics processing units, central processing units, and combinations thereof, and these data processors may be configured to implement the throttling mechanisms disclosed herein.

In at least one embodiment, as depicted in FIG. 8, data center infrastructure layer 802 may include a resource orchestrator 810, grouped computing resources 812, and node computing resources (node C.R.s) 814a-814c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (e.g., dynamic read-only memory), storage devices (e.g., solid state or disk drives), network input/output (NW I/O) devices, network switches, virtual machines (VMs), power modules, and cooling modules, etc. In at least one embodiment, one or more node computing resources from among node computing resources 814a-814c may be a server having one or more of the above-mentioned computing resources.

In at least one embodiment, grouped computing resources 812 may include separate groupings of node computing resources housed within one or more racks (not shown), or many racks housed in data centers at various geographical locations (also not shown). Separate groupings of node computing resources within grouped computing resources 812 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 810 may configure or otherwise control one or more node computing resources 814a-814c and/or grouped computing resources 812. In at least one embodiment, resource orchestrator 810 may include a software design infrastructure (“SDI”) management entity for data center 800. In at least one embodiment, resource orchestrator 810 may include hardware, software, or some combination thereof.

In at least one embodiment, as depicted in FIG. 8, framework layer 804 includes, without limitation, a job scheduler 816, a configuration manager 818, a resource manager 820, and a distributed file system 822. In at least one embodiment, framework layer 804 may include a framework to support software 824 of software layer 806 and/or one or more application(s) 826 of application layer 220. In at least one embodiment, software 824 or application(s) 826 may respectively include web-based service software or applications, such as those provided by Amazon Web Services, Google Cloud, and Microsoft Azure. In at least one embodiment, framework layer 804 may be, but is not limited to, a type of free and open-source software web application framework such as Apache SPARK™ (hereinafter “Spark) that may utilize a distributed file system 822 for large-scale data processing (e.g., “big data”). In at least one embodiment, job scheduler 816 may include a Spark driver to facilitate scheduling of workloads supported by various layers of data center 800. In at least one embodiment, configuration manager 818 may be capable of configuring different layers such as software layer 806 and framework layer 804, including Spark and distributed file system 822 for supporting large-scale data processing. In at least one embodiment, resource manager 820 may be capable of managing clustered or grouped computing resources mapped to or allocated for support of distributed file system 822 and job scheduler 816. In at least one embodiment, clustered or grouped computing resources may include grouped computing resources 812 at data center infrastructure layer 802. In at least one embodiment, resource manager 820 may coordinate with resource orchestrator 810 to manage these mapped or allocated computing resources.

In at least one embodiment, software 824 included in software layer 806 may include software used by at least portions of node computing resources 814a-814c, grouped computing resources 812, and/or distributed file system 822 of framework layer 804. One or more types of software may include, but are not limited to, Internet web page search software, e-mail virus scan software, database software, and streaming video content software.

In at least one embodiment, application(s) 826 included in application layer 808 may include one or more types of applications used by at least portions of node computing resources 814a-814c, grouped computing resources 812, and/or distributed file system 822 of framework layer 804. In at least one or more types of applications may include, without limitation, Compute Unified Device Architecture (CUDA) applications, 5G network applications, artificial intelligence applications, data center applications, and/or variations thereof.

In at least one embodiment, any of configuration manager 818, resource manager 820, and resource orchestrator 810 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poorly performing portions of a data center.

### LISTING OF DRAWING ELEMENTS

102 GPU
104 CPU
106 memory channel controller
108 memory
110 streaming multiprocessor
112 processor core
114 throttling logic
202 Configure sampling time intervals for components
204 block
206 block
302 memory channel
304 DRAM
306 filter
402 Configure asymmetric sampling intervals for feedback from a shared system resource
404 if filter output indicates to throttle down, subtract an amount from the sampling time interval proportional to filter output strength
406 if filter output indicates to throttle up, add an amount from the sampling time interval proportional to filter output strength
502 integrated circuit
504 central processing unit
506 graphics processing unit
508 graphics processing unit
602 computing system
604 network
606 network
608 NIC or DPU
610 NIC or DPU
612 NIC or DPU
614 NIC or DPU
616 NIC or DPU
702 graphics processing unit
704 central processing unit
706 memory
708 NVLink
710 interconnect
800 data center
802 data center infrastructure layer
804 framework layer
806 software layer
808 application layer
810 resource orchestrator
812 grouped computing resources
814a node computing resource
814b node computing resource
814c node computing resource
816 job scheduler
818 configuration manager
820 resource manager
822 distributed file system
824 software
826 application(s)

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A system comprising:
a plurality of data processors each coupled to a shared computing resource;
each of the data processors configured to:
sample, during a time interval, indications of whether the shared computing resource is over-utilized or under-utilized; and
after a conclusion of the time interval, expand or contract the time interval as determined by the indications.

2. The system of claim 1, configured such that expansion or contraction of the time interval by a particular one of the data processors causes an increase or decrease in utilization of the shared computing resource by the particular one of the data processors.

3. The system of claim 1, each of the data processors further configured to maintain a constant outstanding request limit for the shared computing resource.

4. The system of claim 1, wherein each data processor is further configured to expand or contract the time interval by a same amount after the conclusion of the time interval.

5. The system of claim 1, wherein each data processor is further configured to expand or contract the time interval after conclusion of the time interval by an amount proportional to an outstanding request limit for the shared computing resource.

6. The system of claim 1, wherein the shared computing resource is a memory channel.

7. The system of claim 1, wherein the indications of whether the shared computing resource is over-utilized or under-utilized are settings in a data packet returned from the shared computing resource.

8. The system of claim 1, wherein the indications of whether the shared computing resource is over-utilized or under-utilized are provided by a filter.

9. The system of claim 8, wherein the filter is configured to provide a weight or scale factor for an extent of expanding or contracting the time interval.

10. The system of claim 1, wherein each data processor is further configured to:
contract the time interval upon detecting that the resource is over-utilized.

11. The system of claim 1, wherein each data processor is further configured to:
expand the time interval upon detecting that the resource is under-utilized.

12. A method comprising:
for each of a plurality of components each generating requests to use a shared system resource:
configuring a time interval;
sampling during the time interval indications of whether the resource is over-utilized or under-utilized; and
after a conclusion of the time interval, expanding or contracting the time interval as determined by the indications.

13. The method of claim 12, wherein expansion or contraction of the time interval by a particular one of the components causes an increase or decrease in utilization of the shared system resource by the particular one of the components.

14. The method of claim 12, further comprising:
maintaining a constant outstanding transaction limit for each of the components.

15. The method of claim 12, wherein the time interval of each of the components is expanded or contracted by the same amount after the conclusion of each time interval.

16. The method of claim 12, wherein the time interval of each of the components is expanded or contracted by after the conclusion of each time interval by an amount proportional to an outstanding transaction limit configured for the component.

17. The method of claim 12, wherein the resource is a memory channel.

18. The method of claim 12, wherein the indications of whether the resource is over-utilized or under-utilized are settings in a data packet returned from the resource.

19. The method of claim 12, wherein the indications of whether the resource is over-utilized or under-utilized are provided by a filter.

20. The method of claim 19, wherein the filter also provides a weight or scale factor for an extent of expanding or contracting the time interval.

21. The method of claim 12, further comprising:
on condition that the resource is over-utilized, contracting the time interval of each of the components.

22. The method of claim 12, further comprising:
on condition that the resource is under-utilized, expanding the time interval of each of the components.

23. A data center comprising:
a plurality of graphics processing units each coupled to a memory channel;
each of the graphics processing units configured to:
sample, during a time interval, indications of whether the memory channel is over-utilized or under-utilized; and
after a conclusion of the time interval, expand or contract the time interval as determined by the indications.

24. The data center of claim 23, each graphics processing unit configured such that expansion or contraction of the time interval by the graphics processing unit causes an increase or decrease in utilization of the shared computing resource by the graphics processing unit.
